(19) United States
(12) Patent Application Publication
(10) Pub. No.: US 2025/0287424 A1
(43) Pub. Date: Sep. 11, 2025

(54) SYSTEMS AND METHODS FOR COEXISTENCE OF WIRELESS TECHNOLOGIES

(71) Applicant: Meta Platforms Technologies, LLC, Menlo Park, CA (US)

(72) Inventors: Connor Kennedy, San Francisco, CA (US); Muhammad Kumail Haider, Sunnyvale, CA (US); Davide Magrin, Villa del Conte (IT); Guoqing Li, Cupertino, CA (US); Carlos Horacio Aldana, Mountain View, CA (US)

(21) Appl. No.: 19/074,114

(22) Filed: Mar. 7, 2025

Related U.S. Application Data
(60) Provisional application No. 63/562,668, filed on Mar. 7, 2024.

(51) Int. Cl. H04W 74/0808; H04W 72/51

(52) U.S. Cl. CPC H04W 74/0808; H04W 72/51

(57) ABSTRACT

The disclosed computer-implemented method can include sensing, by a computer device, a plurality of wireless communication channels available for narrow band communication. The method can also include detecting, by the computer device, wireless communication data usage of the sensed plurality of communication channels over a predetermined time period. Additionally, the method can include estimating, by the computing device, the wireless communication data usage of the plurality of communication channels over a predetermined time period. Finally, the method can include selecting, by the computing device, at least one channel from the plurality of communication channels to be used for narrow band data transmission, such the wireless communication data and the narrow band data transmission coexist without interference.

### CROSS REFERENCE TO RELATED APPLICATION

This application claims the filing benefit of U.S. Provisional Application No. 63/562,668 filed Mar. 7, 2024, the disclosure of which is incorporated, in its entirety, by this reference.

### BRIEF DESCRIPTION OF DRAWINGS

The accompanying drawings illustrate a number of exemplary embodiments and are a part of the specification. Together with the following description, these drawings demonstrate and explain various principles of the present disclosure.

FIG. 1 is an illustration of exemplary augmented-reality glasses that may be used in connection with embodiments of this disclosure.

FIGS. 2A and 2B are illustrations of an exemplary virtual-reality headset that may be used in connection with embodiments of this disclosure.

FIG. 3 is a flow diagram of an exemplary method for providing the coexistence of multiple wireless technologies over shared communications channels according to some embodiments of this disclosure.

FIG. 4 is an illustration of a channel mapping product according to some embodiments of this disclosure.

FIG. 5 is a flow diagram of an exemplary method for providing the coexistence of multiple wireless technologies over shared communications channels according to some embodiments of this disclosure.

FIG. 6 is a flow diagram of an exemplary method for providing the coexistence of multiple wireless technologies over shared communications channels according to some embodiments of this disclosure.

FIG. 7 is a block diagram of an exemplary system for providing the coexistence of multiple wireless technologies over shared communications channels according to some embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Currently Wi-Fi devices can co-exist well with mandatory channel sensing (CCA) methods. However, most narrow band (NB) technologies, including Bluetooth®, either have insufficient coexistence provisions in terms of sensing the channel before transmissions or none at all. An effective coexistence mechanism for NB technologies does not exist in deployment. With the move to ⅚ GHZ, current coexistence methodologies are insufficient to maintain acceptable Wi-Fi performance (problems exacerbated by higher NB transmit power and much wider Wi-Fi channels). The disclosure addresses how NB systems such as Bluetooth® can maintain good performance while operating in frequency bands currently predominantly occupied by Wi-Fi.

The present disclosure is generally directed to systems and methods for coexistence of wireless technologies. We disclose coexistence systems and methods for NB devices that allow for operable coexistence between NB and Wi-Fi, with particular emphasis on latency sensitive traffic and applications.

In particular, embodiments of this disclosure are directed to a system and/or a method to detect and estimate usage of channels by wireless communication (e.g., Wi-Fi or other technologies) in a predetermined time period, generally to be used before start of all NB traffic flows/services. Some embodiments may also provide a method to detect and estimate usage of channels by Wi-Fi or other technologies over multiple time periods, generally to be used during the flow of NB traffic/services. Additionally or alternatively, embodiments of this disclosure may include a method to do pre-transmission sensing and deferral that can both detect and/or estimate interference and enables good coexistence while sharing the channel(s). Such methods may provide enhanced procedures for NB channel selection to allow for more effective avoidance of channels in use by Wi-Fi and other technologies. Some embodiments may also provide methods for aggregation and usage of the channel detection/usage estimation information.

In some embodiments discussed below, example devices and systems, including electronic devices and systems, will be addressed. Such example devices and systems are not intended to be limiting, and one of skill in the art will understand that alternative devices and systems to the example devices and systems described herein may be used to perform the operations and construct the systems and devices that are described herein.

An electronic device may be a device that uses electrical energy to perform a specific function. An electronic device can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device may be a device that sits between two other electronic devices and/or a subset of components of one or more electronic devices and facilitates communication, data processing, and/or data transfer between the respective electronic devices and/or electronic components.

An integrated circuit may be an electronic device made up of multiple interconnected electronic components such as transistors, resistors, and capacitors. These components may be etched onto a small piece of semiconductor material, such as silicon. Integrated circuits may include analog integrated circuits, digital integrated circuits, mixed signal integrated circuits, and/or any other suitable type or form of integrated circuit. Examples of integrated circuits include application-specific integrated circuits (ASICs), processing units, central processing units (CPUs), co-processors, and accelerators.

Analog integrated circuits, such as sensors, power management circuits, and operational amplifiers, may process continuous signals and perform analog functions such as amplification, active filtering, demodulation, and mixing. Examples of analog integrated circuits include linear integrated circuits and radio frequency circuits.

Digital integrated circuits, which may be referred to as logic integrated circuits, may include microprocessors, microcontrollers, memory chips, interfaces, power management circuits, programmable devices, and/or any other suitable type or form of integrated circuit. In some embodiments, examples of integrated circuits include central processing units (CPUs),

Processing units, such as CPUs, may be electronic components that are responsible for executing instructions and controlling the operation of an electronic device (e.g., a computer). There are various types of processors that may be used interchangeably, or may be specifically required, by embodiments described herein. For example, a processor may be: (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) an accelerator, such as a graphics processing unit (GPU), designed to accelerate the creation and rendering of images, videos, and animations (e.g., virtual-reality animations, such as three-dimensional modeling); (iv) a field-programmable gate array (FPGA) that can be programmed and reconfigured after manufacturing and/or can be customized to perform specific tasks, such as signal processing, cryptography, and machine learning; and/or (v) a digital signal processor (DSP) designed to perform mathematical operations on signals such as audio, video, and radio waves. One or more processors of one or more electronic devices may be used in various embodiments described herein.

Memory generally refers to electronic components in a computer or electronic device that store data and instructions for the processor to access and manipulate. Examples of memory can include: (i) random access memory (RAM) configured to store data and instructions temporarily; (ii) read-only memory (ROM) configured to store data and instructions permanently (e.g., one or more portions of system firmware, and/or boot loaders) and/or semi-permanently; (iii) flash memory, which can be configured to store data in electronic devices (e.g., USB drives, memory cards, and/or solid-state drives (SSDs)); and/or (iv) cache memory configured to temporarily store frequently accessed data and instructions. Memory, as described herein, can store structured data (e.g., SQL databases, MongoDB databases, GraphQL data, JSON data, etc.). Other examples of data stored in memory can include (i) profile data, including user account data, user settings, and/or other user data stored by the user, (ii) sensor data detected and/or otherwise obtained by one or more sensors, (iii) media content data including stored image data, audio data, documents, and the like, (iv) application data, which can include data collected and/or otherwise obtained and stored during use of an application, and/or any other types of data described herein.

Controllers may be electronic components that manage and coordinate the operation of other components within an electronic device (e.g., controlling inputs, processing data, and/or generating outputs). Examples of controllers can include: (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs.

A power system of an electronic device may be configured to convert incoming electrical power into a form that can be used to operate the device. A power system can include various components, such as (i) a power source, which can be an alternating current (AC) adapter or a direct current (DC) adapter power supply, (ii) a charger input, which can be configured to use a wired and/or wireless connection (which may be part of a peripheral interface, such as a USB, micro-USB interface, near-field magnetic coupling, magnetic inductive and magnetic resonance charging, and/or radio frequency (RF) charging), (iii) a power-management integrated circuit, configured to distribute power to various components of the device and to ensure that the device operates within safe limits (e.g., regulating voltage, controlling current flow, and/or managing heat dissipation), and/or (iv) a battery configured to store power to provide usable power to components of one or more electronic devices.

Peripheral interfaces may be electronic components (e.g., of electronic devices) that allow electronic devices to communicate with other devices or peripherals and can provide the ability to input and output data and signals. Examples of peripheral interfaces can include (i) universal serial bus (USB) and/or micro-USB interfaces configured for connecting devices to an electronic device, (ii) Bluetooth interfaces configured to allow devices to communicate with each other, including Bluetooth low energy (BLE), (iii) near field communication (NFC) interfaces configured to be short-range wireless interfaces for operations such as access control, (iv) POGO pins, which may be small, spring-loaded pins configured to provide a charging interface, (v) wireless charging interfaces, (vi) GPS interfaces, (vii) Wi-Fi interfaces for providing a connection between a device and a wireless network, and/or (viii) sensor interfaces.

Sensors may be electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device), (ii) biopotential-signal sensors, (iii) inertial measurement units (e.g., IMUs) for detecting, for example, angular rate, force, magnetic field, and/or changes in acceleration, (iv) heart rate sensors for measuring a user's heart rate, (v) SpO2 sensors for measuring blood oxygen saturation and/or other biometric data of a user, (vi) capacitive sensors for detecting changes in potential at a portion of a user's body (e.g., a sensor-skin interface), and/or (vii) light sensors (e.g., time-of-flight sensors, infrared light sensors, visible light sensors, etc.).

Biopotential-signal-sensing components may be devices used to measure electrical activity within the body (e.g., biopotential-signal sensors). Some types of biopotential-signal sensors include (i) electroencephalography (EEG) sensors configured to measure electrical activity in the brain to diagnose neurological disorders, (ii) electrocardiography (ECG or EKG) sensors configured to measure electrical activity of the heart to diagnose heart problems, (iii) electromyography (EMG) sensors configured to measure the electrical activity of muscles and to diagnose neuromuscular disorders, and (iv) electrooculography (EOG) sensors configure to measure the electrical activity of eye muscles to detect eye movement and diagnose eye disorders.

An application stored in memory of an electronic device (e.g., software) may include instructions stored in the memory. Examples of such applications include (i) games, (ii) word processors, (iii) messaging applications, (iv) media-streaming applications, (v) financial applications, (vi) calendars. (vii) clocks, and (viii) communication interface modules for enabling wired and/or wireless connections between different respective electronic devices (e.g., IEEE 802.15.4, Wi-Fi, ZigBee, 6LOWPAN, Thread, Z-Wave, Bluetooth Smart, ISA100.11a, WirelessHART, or MiWi), custom or standard wired protocols (e.g., Ethernet or HomePlug), and/or any other suitable communication protocols).

A communication interface may be a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, Bluetooth). In some embodiments, a communication interface can refer to a software layer that enables different software programs to communicate with each other (e.g., application programming interfaces (APIs), protocols like HTTP and TCP/IP, etc.).

A graphics module may be a component or software module that is designed to handle graphical operations and/or processes and can include a hardware module and/or a software module.

Non-transitory computer-readable storage media may be physical devices or storage media that can be used to store electronic data in a non-transitory form (e.g., such that the data is stored permanently until it is intentionally deleted or modified).

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

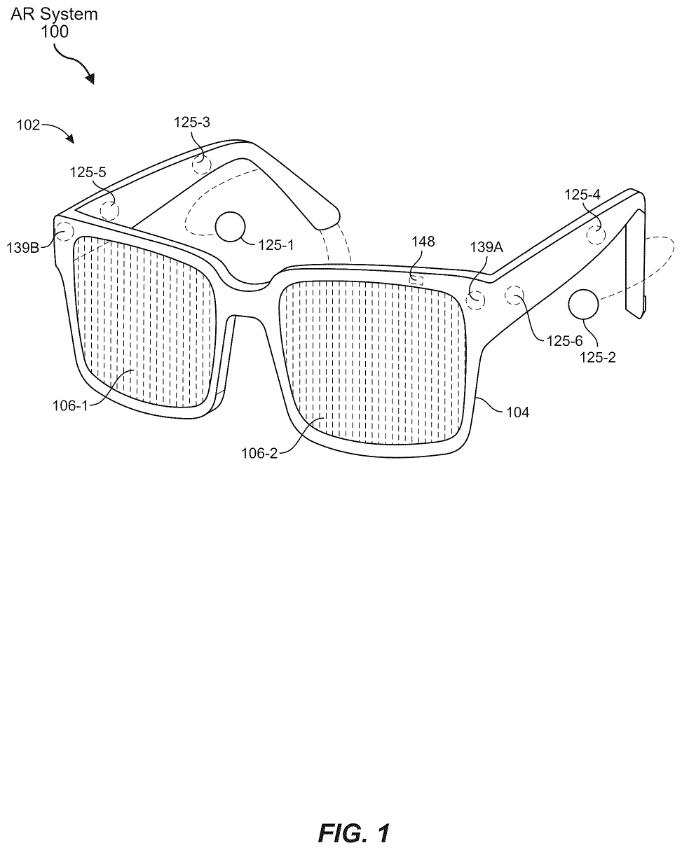

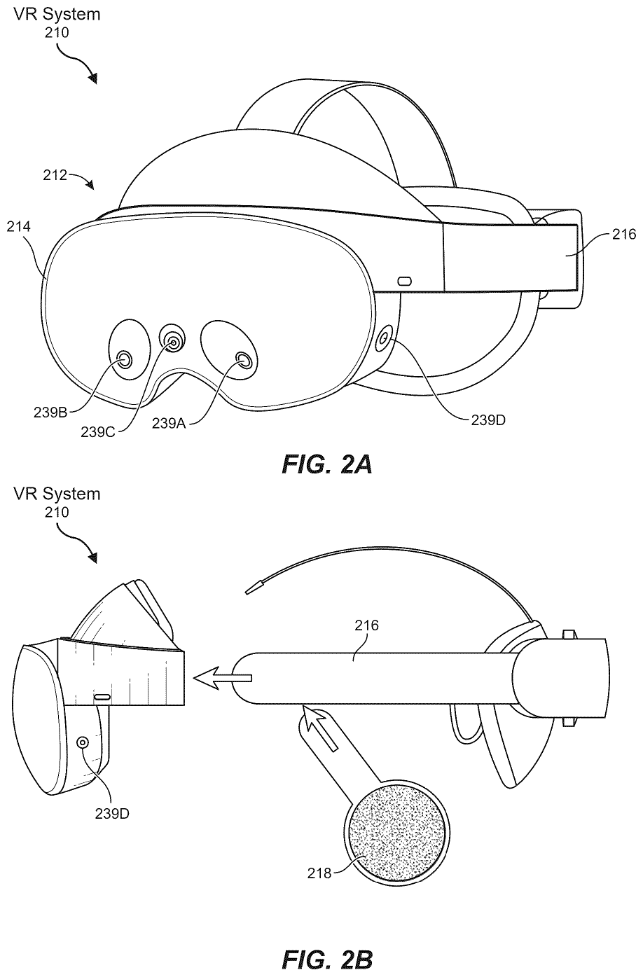

Artificial-reality systems may be implemented in a variety of different form factors and configurations. Some artificial-reality-systems may be designed to work without near-eye displays (NEDs). Other artificial-reality systems may include an NED that also provides visibility into the real world (such as, e.g., augmented-reality system 100 in FIG. 1) or that visually immerses a user in an artificial reality (such as, e.g., virtual-reality system 200 in FIG. 2). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

FIGS. 1 to 2B show example artificial-reality systems, which can be used as or in connection with a wrist-wearable device. In some embodiments, AR system 100 includes an eyewear device 102, as shown in FIG. 1. In some embodiments, VR system 210 includes a head-mounted display (HMD) 212, as shown in FIGS. 2A and 2B. In some embodiments, AR system 100 and VR system 210 can include one or more analogous components (e.g., components for presenting interactive artificial-reality environments, such as processors, memory, and/or presentation devices, including one or more displays and/or one or more waveguides), some of which are described in more detail with respect to FIG. 10. As described herein, a head-wearable device can include components of eyewear device 102 and/or head-mounted display 212. Some embodiments of head-wearable devices do not include any displays, including any of the displays described with respect to AR system 100 and/or VR system 210. While the example artificial-reality systems are respectively described herein as AR system 100 and VR system 210, either or both of the example AR systems described herein can be configured to present fully-immersive virtual-reality scenes presented in substantially all of a user's field of view or subtler augmented-reality scenes that are presented within a portion, less than all, of the user's field of view.

FIG. 1 shows an example visual depiction of AR system 100, including an eyewear device 102 (which may also be described herein as augmented-reality glasses, and/or smart glasses). AR system 100 can include additional electronic components that are not shown in FIG. 1, such as a wearable accessory device and/or an intermediary processing device, in electronic communication or otherwise configured to be used in conjunction with the eyewear device 102. In some embodiments, the wearable accessory device and/or the intermediary processing device may be configured to couple with eyewear device 102 via a coupling mechanism in electronic communication with a coupling sensor 1024 (FIG. 10), where coupling sensor 1024 can detect when an electronic device becomes physically or electronically coupled with eyewear device 102. In some embodiments, eyewear device 102 can be configured to couple to a housing 1090 (FIG. 10), which may include one or more additional coupling mechanisms configured to couple with additional accessory devices. The components shown in FIG. 1 can be implemented in hardware, software, firmware, or a combination thereof, including one or more signal-processing components and/or application-specific integrated circuits (ASICs).

Eyewear device 102 includes mechanical glasses components, including a frame 104 configured to hold one or more lenses (e.g., one or both lenses 106-1 and 106-2). One of ordinary skill in the art will appreciate that eyewear device 102 can include additional mechanical components, such as hinges configured to allow portions of frame 104 of eyewear device 102 to be folded and unfolded, a bridge configured to span the gap between lenses 106-1 and 106-2 and rest on the user's nose, nose pads configured to rest on the bridge of the nose and provide support for eyewear device 102, earpieces configured to rest on the user's ears and provide additional support for eyewear device 102, temple arms configured to extend from the hinges to the earpieces of eyewear device 102, and the like. One of ordinary skill in the art will further appreciate that some examples of AR system 100 can include none of the mechanical components described herein. For example, smart contact lenses configured to present artificial reality to users may not include any components of eyewear device 102.

Eyewear device 102 includes electronic components, many of which will be described in more detail below with respect to FIG. 10. Some example electronic components are illustrated in FIG. 1, including acoustic sensors 125-1, 125-2, 125-3, 125-4, 125-5, and 125-6, which can be distributed along a substantial portion of the frame 104 of eyewear device 102. Eyewear device 102 also includes a left camera 139A and a right camera 139B, which are located on different sides of the frame 104. Eyewear device 102 also includes a processor 148 (or any other suitable type or form of integrated circuit) that is embedded into a portion of the frame 104.

FIGS. 2A and 2B show a VR system 210 that includes a head-mounted display (HMD) 212 (e.g., also referred to herein as an artificial-reality headset, a head-wearable device, a VR headset, etc.), in accordance with some embodiments. As noted, some artificial-reality systems (e.g., AR system 100) may, instead of blending an artificial reality with actual reality, substantially replace one or more of a user's visual and/or other sensory perceptions of the real world with a virtual experience (e.g., AR systems 400 and 500).

HMD 212 includes a front body 214 and a frame 216 (e.g., a strap or band) shaped to fit around a user's head. In some embodiments, front body 214 and/or frame 216 include one or more electronic elements for facilitating presentation of and/or interactions with an AR and/or VR system (e.g., displays, IMUs, tracking emitter or detectors). In some embodiments, HMD 212 includes output audio transducers (e.g., an audio transducer 218), as shown in FIG. 2B. In some embodiments, one or more components, such as the output audio transducer(s) 218 and frame 216, can be configured to attach and detach (e.g., are detachably attachable) to HMD 212 (e.g., a portion or all of frame 216, and/or audio transducer 218), as shown in FIG. 2B. In some embodiments, coupling a detachable component to HMD 212 causes the detachable component to come into electronic communication with HMD 212.

FIGS. 2A and 2B also show that VR system 210 includes one or more cameras, such as left camera 239A and right camera 239B, which can be analogous to left and right cameras 139A and 139B on frame 104 of eyewear device 102. In some embodiments, VR system 210 includes one or more additional cameras (e.g., cameras 239C and 239D), which can be configured to augment image data obtained by left and right cameras 239A and 239B by providing more information. For example, camera 239C can be used to supply color information that is not discerned by cameras 239A and 239B. In some embodiments, one or more of cameras 239A to 239D can include an optional IR cut filter configured to remove IR light from being received at the respective camera sensors.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 200 in FIG. 2, that mostly or completely covers a user's field of view. Virtual-reality system 200 may include a front rigid body 202 and a band 204 shaped to fit around a user's head. Virtual-reality system 200 may also include output audio transducers 206 (A) and 206 (B). Furthermore, while not shown in FIG. 2, front rigid body 202 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 100 and/or virtual-reality system 200 may include one or more liquid crystal displays (LCDs), light emitting diode (LED) displays, microLED displays, organic LED (OLED) displays, digital light project (DLP) micro-displays, liquid crystal on silicon (LCOS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 100 and/or virtual-reality system 200 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 100 and/or virtual-reality system 200 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial--reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the operations described and/or illustrated herein are given by way of example only and can be varied as desired. For example, while the operations illustrated and/or described herein may be shown or discussed in a particular order, these operations do not necessarily need to be performed in the order illustrated or discussed. The various exemplary methods described and/or illustrated herein may also omit one or more of the operations described or illustrated herein or include additional operations in addition to those disclosed.

Having discussed example AR systems, devices for interacting with such AR systems and other computing systems more generally will now be discussed in greater detail. Some explanations of devices and components that can be included in some or all of the example devices discussed below are explained herein for ease of reference. Certain types of the components described below may be more suitable for a particular set of devices, and less suitable for a different set of devices. But subsequent reference to the components explained here should be considered to be encompassed by the descriptions provided.

The various exemplary systems described above can simultaneously use NB and Wi-Fi communications to provide the user experience. For example, pairing external devices with augmented-reality eyewear devices (e.g., XR (AR or VR)) can provide the benefits recited above, however can also cause communication issues when concomitantly using Wi-Fi services. As most narrow band (NB) technologies, including Bluetooth®, either have insufficient coexistence provisions in terms of sensing the channel before transmissions or none at all, a method to improve the coexistence of NB and Wi-Fi will be described.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

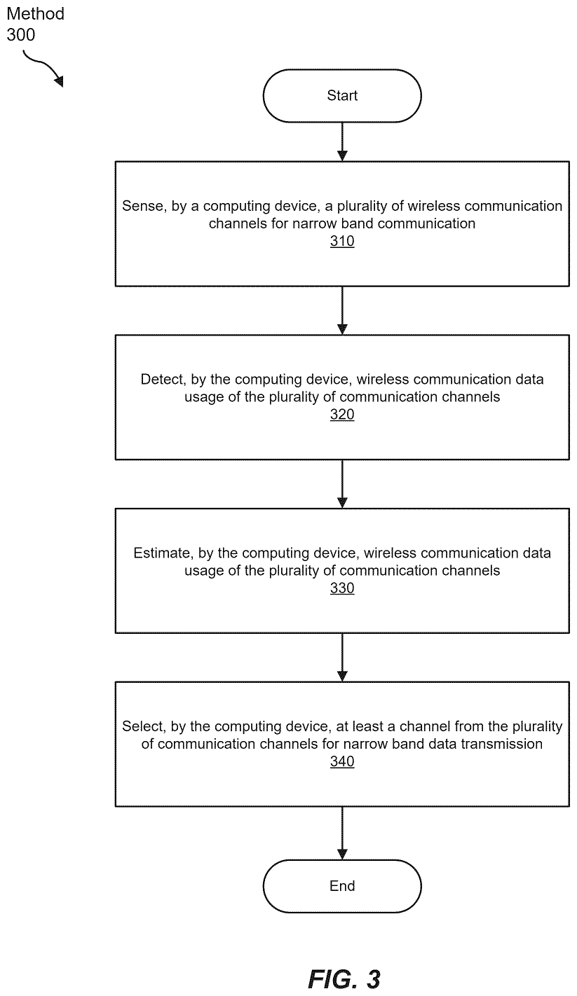

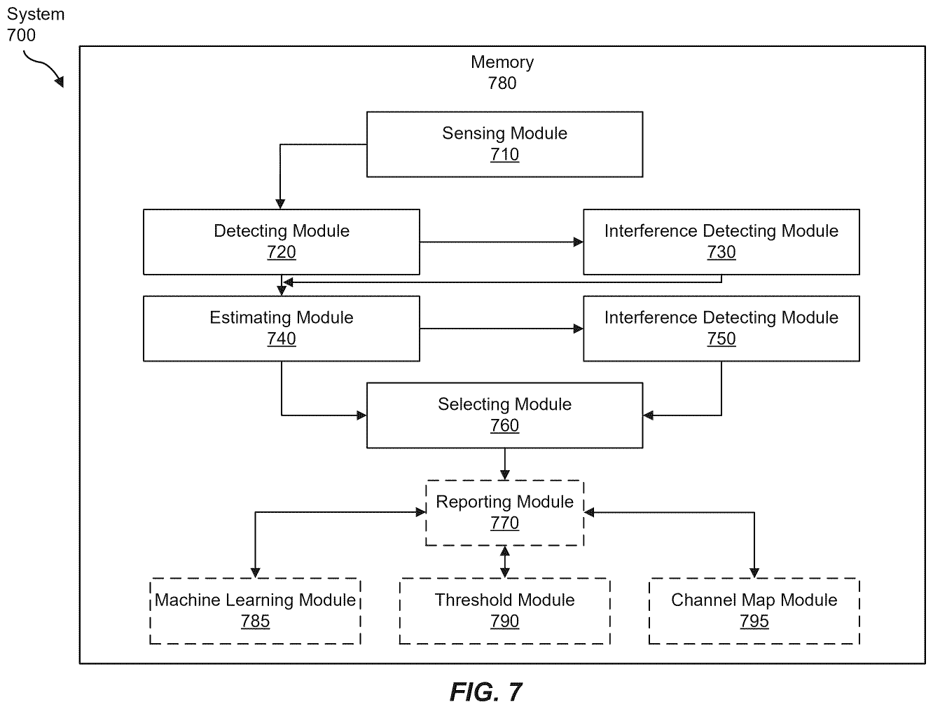

FIG. 3 is a flow diagram of an exemplary computer-implemented method 300 for providing a coexistence of wireless technologies. The operations shown in FIG. 3 may be performed by any suitable computer-executable code and/or computing system, including the devices and systems described above and illustrated in FIG. 7. In some examples, performing each operation of method 300 can be referred to as a “full scan” or a “scan,” or “scans” if method 300 is repeated. In one example, each of the operations shown in FIG. 3 may represent an algorithm whose structure includes and/or is represented by multiple sub-operations, examples of which will be provided in greater detail below.

The systems described herein may perform operation 310 in a variety of ways. In one example, as illustrated in FIG. 3, at operation 310 one or more of the systems described herein can sense, by a computing device, a plurality of wireless communication channels for NB communication (e.g., NB data transmission and/or NB data receiving). For example, a NB device can sense a range of wireless communication channels that the NB device intends to operate on to detect utilization of these channels by Wi-Fi and/or other wireless technologies (including NB technologies such as Bluetooth®).

In some embodiments, the NB device can perform the sensing operation 310 before NB data transmission (e.g., a Listen Before Talk (LBT) operation), where the NB devices transmits NB data if no energy is sensed or the sensed energy is below a detection threshold, for example, −75 decibel·milliwatts (dBm) or −62 dBm. For example, the sensing operation 310 can be used to detect whether a sensed channel contains energy indicating that the sensed channel is in use by a wireless technology. In some embodiments, the NB device can proceed with NB data transmission when certain predetermined criteria are met. For example, the device may transmit on an in-use wireless communication channel unconditionally if the NB device previously deferred (e.g., marked as busy) the in-use wireless communication channel for a certain number of iterations. Additionally, the NB device can transmit the NB data unconditionally if the data to be transmitted exceeds a certain queueing delay. In some embodiments, other information may be considered including current duty cycle, estimated external device duty cycle, sensed state of the wireless communication channel, and/or a detected energy level. For example, a channel exhibiting a low duty cycle during the detecting operation 320 can be marked as available for NB data transmission. In some embodiments, pre-transmission sensing can be performed by a subset of the NB system (e.g., a communicably coupled peripheral device, an ancillary component, or the like). In further embodiments, the pre-transmission wireless communication channel sensing data can be used whether NB data transmission occurs or not.

In some embodiments, the NB device can maintain NB data transmission on a selected wireless communication channel and perform another sensing operation 310 after completing a NB data transmission, e.g., post-transmission sending. A post-transmission sensing operation is highly advantageous to detect interference/data transmission in examples where other devices (e.g., NB or wide band) can be operating on the selected wireless communication channel and deferring (postponing) data transmission until the channel is available. For example, the other devices may have initiated a wireless communication channel sensing while the NB device is transmitting NB data.

The systems described herein may perform operation 320 in a variety of ways. In one example, at operation 320 the NB device can detect, by the computing device, any wireless communication data usage of the plurality of sensed wireless communication channels. For example, at operation 320 the system can detect the presence of another technology, or the system can detect the bandwidth consumed by the other technology. In some embodiments, the detecting operation 320 can occur in a single predetermined time period such that the detecting operation 320 need not pause for data transmission. In a preferred embodiment, performing the detecting operation 320 in a single time period can be performed prior to the flow of communications traffic (e.g., prior to a data transmission). In some embodiments, the single time period can include a predetermined stopping point.

In other embodiments, the NB device can repeatedly sense the wireless communication channel (or a group of channels occupied by a wider-band technology) to estimate the percentage (or relative) utilization of these channels. In some embodiments, at operation 330 the NB device can estimate, by the computing device, the wireless communication data usage of the plurality of communication channels by performing the sensing and/or detecting operations 310, 320 over a plurality of time periods. In other words, the NB device can perform the sensing and detecting operations 310, 320 repeatedly to build an estimated channel usage based on preceding sensing and detecting operations 310, 320. Likewise, the estimating operation 330 can be performed over a plurality of time periods to continually optimize channel selection and the coexistence of the NB and other wireless data transmissions.

In some embodiments, the information collected by the sensing operation 310, the detecting operation 320, and the estimating operation 330 may be expanded. The systems described herein may perform operation 330 in a variety of ways. In one example, during a scan, the NB device may select a subsequent wireless communication channel to sense according to a predetermined set of criteria including, for example, the current Wi-Fi segment being scanned, the segment of the subsequent channel to scan, the difference in center frequencies of the channels, and how recently the channel or channel segment was scanned. The NB device may choose a different segment to maximize the probability of intercepting an in-progress wide band transmission or to distinguish NB interference from wide band interference. In other words, the NB device can sense and/or detect a wide band correlation among separate wireless communication channels. For example, if a plurality of neighboring channels exhibit similar usage and/or interference, it is likely that the source is a wide band (e.g., Wi-Fi) data transmission. The NB device can store this information and use the information in subsequent scans to avoid unnecessary scanning of such wireless communication channels.

In some embodiments, the NB device may use different energy detection (ED) thresholds for different types of scanning. For example, the NB device can use a higher sensitivity ED threshold (e.g., −75 dBm) for its pre-transmission sensing operation to identify a lower quantity of available wireless communication channels exhibiting a lower percentage of wireless communication data usage. Alternatively, the NB device can use a lower sensitivity ED threshold (e.g., −62 dBm) for all scanning to identify a higher quantity of available wireless communication channels exhibiting a higher percentage of wireless communication data usage.

The systems described herein may perform operation 340 in a variety of ways. In one example, as shown in FIG. 3, at operation 340, the NB device can select, by the computing device, at least one channel from the plurality of communication channels to use for NB data transmission. In some embodiments, the NB device may hop between multiple channels while in other embodiments, the NB device can operate on one channel. For example, wireless communication channels determined as busy (e.g., consumed by a high percentage of Wi-Fi transmission, having a high percentage of interference, or the like) may be deemed unacceptable for the NB data transmission, while in others the NB device may operate on these channels with additional rules and restrictions (e.g., performing the sensing operation 310 before NB data transmission or operating for a lesser duration compared to channels which are determined to be available for NB data transmission).

In some embodiments, the selecting operation 340 can include determining a maximum threshold for the wireless communication data usage on a communication channel for the coexistence of NB and other wireless data transmission. For example, the NB device can initiate the narrow band data transmission when the wireless communication data usage is less than the determined threshold. As the threshold value can vary, it should be noted that the threshold value can be dynamically determined to maintain an optimal NB and wireless data transmission coexistence. In some embodiments, the NB device can use threshold values of either −75 dBm or −62 dBm when scanning Wi-Fi segments having a frequency of 20 MHz.

For example, an AR or a VR device, as illustrated in FIGS. 1 and 2, can be downloading a user experience from a Wi-Fi source while connected to a peripheral device over NB technology. The channels used for the download can be detected as busy and the NB device can select another channel for the NB data transmission. After the download is complete, the NB device ca begin to occupy the channels used for the download.

In other examples, the user experience can be a streamed experience and the communication channels occupied by Wi-Fi can be continuously busy, and the NB device can choose other and/or more open channels, having a threshold value sufficiently low to allow for coexisting NB and other wireless data transmission. For example, a lower threshold value of −62 dBm can be used to determine that an in-use wireless communication channel is available for NB data transmission.

In some embodiments, the NB device may operate on a subset of selected wireless communication channels (e.g., wireless communication channels available for NB data transmission) and can expand to more channels as the NB device operates. In other embodiments, the NB device can reduce the quantity of channels used for NB data transmission. In some embodiments, the NB device may scan a reduced quantity of wireless communication channels before initiating an operation to reduce booting time of a user experience service. The NB device can subsequently scan more wireless communication channels during use and expand the operating channel set as needed. In some embodiments, channels deemed busy during a previous scan can be removed from the subset of selected wireless communication channels until a subsequent scan senses the removed wireless communication channels are available for NB data transmission.

In some embodiments, the NB device can use a minimum amount of time to perform method 300. For example, the NB device may be required to spend a minimum percentage of time per specified time period (e.g., per second) per operating channel (or group of channels) performing the scanning of method 300. In some embodiments, the minimum amount of time to sense wireless communication data usage on a channel may be determined by regulatory requirements or requirements of a standardization or certification body/entity for a particular NB device. In other embodiments, the minimum time can be controlled by NB device constraints (e.g., power consumption, Wi-Fi transmission detection probability, or the like).

In some embodiments, the NB device can arrange the sensed wireless communication channels into sub-groups corresponding to a wireless transmission frequency. For example, Wi-Fi segments having various frequencies (e.g., X megahertz (MHz)) can be sensed for a minimum time (e.g., Y milliseconds (ms)). In some embodiments, values for X and Y be chosen to maximize the probability of detection, channel utilization, and/or X and Y can be mandated by a regulatory or standards body. In some embodiments, wireless communication channels in multiple Wi-Fi segments can be scanned concurrently by switching between the wireless communication channels with a maximum time of Z microseconds (us) between two sensing events on channels of the same Wi-Fi segment. In other embodiments, the NB device can scan multiple channels within the same Wi-Fi segment consecutively before hopping to a channel in a different Wi-Fi segment to distinguish between wide band (WB) interference and NB interference.

In some embodiments, the NB device can perform the sensing operation 310 and/or the detecting operation 320 for a period of time corresponding to one beacon interval (e.g., for about 100 ms). For example, a beacon can be sent on a primary wireless communication channel within a Wi-Fi segment and the NB device can sense and/or detect the Wi-Fi beacon and mark the primary wireless communication channel in the Wi-Fi segment as unavailable. Accordingly, sensing and/or detecting for one beacon interval can optimize the detection probability of a Wi-Fi beacon on, for example, a 20 MHz Wi-Fi segment. For example, the NB device can, by a machine learning module stored in the computing device memory, dynamically modify the duration of the sensing operation 310 and/or the detecting operation 320, extending a predetermined time period. In other embodiments, the NB device can maintain the predetermined time period, switching out of the Wi-Fi segment at a previously determined point in time. For example, when the NB device observes energy on at least X channels within the same Wi-Fi segment in consecutive sensing/detecting events, the NB device can identify the channel as being used by a Wi-Fi device. In other examples, the NB device can identify any interference as originating from another NB technology and/or other wide band interference. In some embodiments, the NB device can perform further sensing/detecting in wireless communication channels in other segments to determine the bandwidth of wide band interference.

In some embodiments, scanning a 20 MHz Wi-Fi segment, including 10 wireless communication channels, can be performed by scanning each channel in 2 MHZ increments. Accordingly, scan time can be reduce significantly by performing such 10% scans as opposed to performing full 20 MHz scans on each wireless communication channel in the 20 MHz Wi-Fi segment.

In some embodiments, the NB device may use external input channel sensing or wireless communication channel usage data from other devices/technologies to supplement an initial scan. In some embodiments, the external input may come from a co-located Wi-Fi chipset of the NB device, a second NB device, or any other suitable external input source. In some embodiments, external input can originate from within the NB device. For example, a NB chip set and a wide band chip set can both be contained in the NB device. As such, the NB chip set and the wide band chip set can communicate wireless communication channel usage and interference data locally without performing any of the operations provided in method 300.

In some embodiments, the NB device can scan (e.g., perform method 300) over a range of in-use and/or planned-use wireless communication channels to detect the presence, percentage, and/or relative utilization of the sensed wireless communication channels by Wi-Fi and other wireless technologies (including Bluetooth®). In some embodiments, such a scan may encompass many brief scans, which can be ideal to use during active data transmission. Additionally, such a scan can be used to collect information over a predetermined period of time. In some embodiments, a continuous output of such a scanning operation can be used to periodically update the channel(s) the NB device can use for NB data transmissions. In some embodiments, the NB device may hop between multiple channels while in some, it may operate on the same channel.

In some embodiments, a channel-hopping NB device can use a channel map to determine which channels to operate on for transmissions out of all available channels. For certain NB devices (e.g., Bluetooth®), each channel in the map currently can be represented by a single bit (e.g., a 1 or a 0), indicating whether or not to use a particular channel. For example, wireless communication channels identified as unusable can be marked with a 0, and wireless communication channels available for NB data transmission can be marked with a 1. In some embodiments, the NB device can remark a channel under predetermined circumstances, including: (i) marked as usable through a forced low periodicity scan, (ii) marked unusable until the device runs out of usable channels, (iii) after a period of time, or (iv) through another method or combinations or these methods. In other words, under certain criteria as described above, the NB device can change a status of the sensed/detected wireless communication channel.

In some embodiments, the NB device may modify method 300 to distinguish detected wide band interference from detected NB interference. For example, the NB device can modify the channel scanning procedure (e.g., method 300) by scanning multiple wireless communication channels within a single Wi-Fi segment consecutively before hopping to a channel in another Wi-Fi segment to sense any wide band data transmission on multiple channels. In some embodiments, the NB device can distinguish NB data transmission based on a higher signal to interference plus noise ratio (SINR) compared to wide band at the same transmission power and distance. In other embodiments, the NB device may identify a Bluetooth® preamble to confirm Bluetooth® NB data transmission. For example, the NB device can track SINR data and leverage SINR statistics to increase the probability of discovering available wireless communication channels for NB data transmission.

In some embodiments, the NB device can use a channel map with multiple bits per channel to enable a channel sensing/detecting frequency, allowing the device to lower its use of heavily used NB channels and more efficiently coexist with multiple WB systems. In some embodiments, values stored in the map can represent a relative frequency at which each sensed wireless communication channel can be subject to the detecting operation 320. For example, a channel with a value of 3 in the channel map can be subjected to the detecting operation 320 three times as often as a channel with a value of 1 in the channel map. In other embodiments, values stored in the map can represent a relative sparsity at which each sensed wireless communication channel can be subject to the detecting operation 320. For example, a channel with a value of 1 in the channel map can be subjected to the detecting operation 320 three times as often as a channel with a value of 3 in the channel map. In other words, multi-bit channel mapping can provide a weighted variable used to determine wireless communication channels to scan more or less frequently.

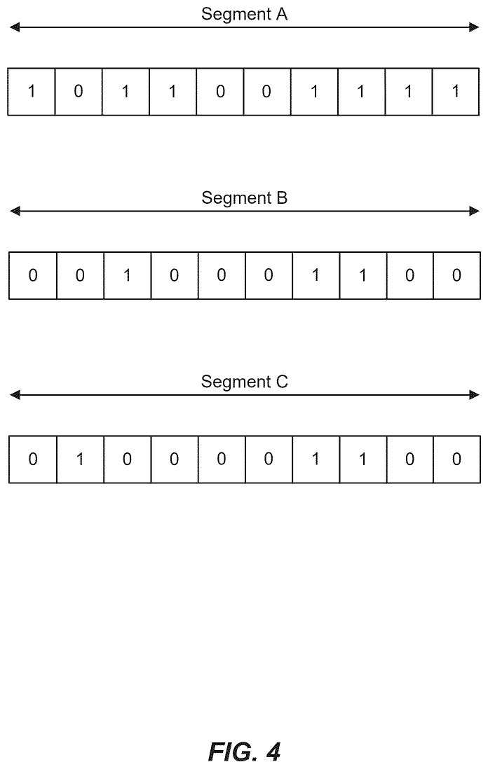

In some embodiments, channel values may be set in groups of channels delineated by Wi-Fi segment, providing relative channel group sensing. For example, the NB device can use a channel map with a single bit per channel but provide the relative segment visitation through identifying a percentage of channels in a Wi-Fi segment as operable for transmission based on the desired relative time per segment. FIG. 4 is an illustration of a channel map as described. Shown in FIG. 4, Segment A includes 7 channels available for NB data transmission (indicated by a “1”), Segment B includes 3 channels available for NB data transmission, and Segment C has 3 channels available for NB data transmission. In the example of FIG. 4, each segment includes 10 sensed wireless communication channels.

For example, the NB device can scan each segment multiple times. In the example of FIG. 4, the NB device can scan Segment A 7 times, Segment B 3 times, Segment C 3 times, and Segment B 7 times to build a higher probability of discovering an available wireless communication channel for NB data transmission.

In some embodiments, the NB device can aggregate information received from performing the operations listed in method 300. The aggregated information can be used to update (e.g., once and/or continuously) the channel map (FIG. 4). For example, information from a previous full scan, scans performed between transmissions, and/or results from per-transmission sensing can be used, considering the quantity of interference detected as a function of the amount of time spent scanning. In some embodiments, information from an initial scan may be replaced by external input such as provided by a co-located Wi-Fi chipset or another NB device. Additionally, in some embodiments other information indicating an amount of interference can be included in the aggregate, for example, received power. As such, a running average of the scan information can be stored as an update to the channel map. In some examples, the NB device can include information such as per-channel packet error rate (PER) or received packet SINR when determining how to update a specific channel on the channel map. In some embodiments, this information may be calculated on a per-segment basis. In further embodiments, the NB device can store and iterate the information upon an intermediate version of the channel map to synthesize results over longer periods of time.

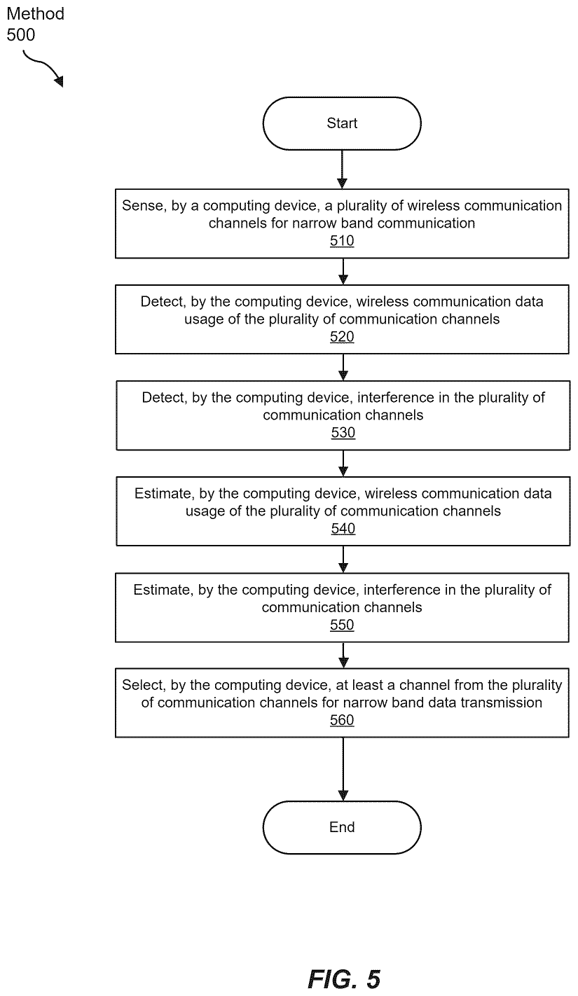

FIG. 5 is a flow diagram of an exemplary computer-implemented method 500 for providing a coexistence of wireless technologies. The operations shown in FIG. 5 may be performed by any suitable computer-executable code and/or computing system, including the system illustrated in FIG. 7. In one example, each of the operations shown in FIG. 5 may represent an algorithm whose structure includes and/or is represented by multiple sub-operations, examples of which will be provided in greater detail below.

The systems described herein may perform operation 510 in a variety of ways. In one example, as illustrated in FIG. 5, at operation 510 one or more of the systems described herein can sense, by a computing device, a plurality of wireless communication channels for NB communication (e.g., NB data transmission and/or NB data receiving). For example, a NB device can sense a range of wireless communication channels that the NB device intends to operate on to detect utilization of these channels by Wi-Fi and/or other wireless technologies (including Bluetooth®).

The systems described herein may perform operation 520 in a variety of ways. In one example, at operation 520 the NB device can detect, by the computing device, any wireless communication data usage of the plurality of sensed wireless communication channels. For example, at operation 520 the system can detect the presence of another technology, or the system can detect the bandwidth consumed by the other technology. In some embodiments, the detecting operation 520 can occur in a single predetermined time period such that the detecting operation 520 need not pause for data transmission. In a preferred embodiment, performing the detecting operation 520 in a single time period can be performed prior to the flow of communications traffic (e.g., prior to a data transmission). In some embodiments, the single time period can include a predetermined stopping point.

The systems described herein may perform operation 530 in a variety of ways. In one example, at operation 530 the NB device can detect, by the computing device, any interference in the sensed wireless communication channels. For example, at operation 530 the system can detect the presence of interference from another technology and/or a co-located technology. In some embodiments, the detecting operation 530 can occur in a single predetermined time period such that the detecting operation 530 need not pause for data transmission. In a preferred embodiment, performing the detecting operation 530 in a single time period can be performed prior to the flow of communications traffic (e.g., prior to a data transmission). In some embodiments, the single time period can include a predetermined stopping point.

In other embodiments, the NB device can repeatedly sense the wireless communication channel (or a group of channels occupied by a wider-band technology) to estimate the percentage (or relative) utilization of the sensed wireless communication channels. The systems described herein may perform operation 540 in a variety of ways. In one example, at operation 540 the NB device can estimate, by the computing device, the wireless communication data usage of the plurality of communication channels by performing the detecting operation 520 over a plurality of time periods. In other words, the NB device can perform the sensing and detecting operations 510, 520 repeatedly to build an estimated channel usage based on preceding sensing and detecting operations 510, 520. Likewise, the estimating operation 530 can be performed over a plurality of time periods to continually optimize channel selection and the coexistence of the NB and other wireless data transmissions.

In other embodiments, the NB device can repeatedly sense the wireless communication channel (or a group of channels occupied by a wider-band technology) to estimate the interference within the sensed wireless communication channels. The systems described herein may perform operation 550 in a variety of ways. In one example, at operation 550, the NB device can estimate, by the computing device, the interference in the plurality of communication channels by performing the detecting operation 530 over a plurality of time periods. In other words, the NB device can perform the sensing and detecting operations 510, 530 repeatedly to build an estimated interference quantity based on preceding sensing and detecting operations 510, 530. Likewise, the estimating operation 550 can be performed over a plurality of time periods to continually optimize channel selection and the coexistence of the NB and other wireless data transmissions.

The systems described herein may perform operation 560 in a variety of ways. In one example, as shown in FIG. 5, at operation 560, the NB device can select, by the computing device, at least one channel from the plurality of communication channels to use for NB data transmission. In some embodiments, the NB device may hop between multiple channels while in other embodiments, the NB device can operate on one channel. In some embodiments, wireless communication channels determined as busy (e.g., consumed by a high percentage of Wi-Fi transmission, having too much interference, or the like) may be deemed unacceptable for the NB data transmission, while in others the NB device may operate on these channels with additional rules and restrictions (e.g., performing the sensing operation 310 before NB data transmission or operating for a lesser duration compared to channels which are determined to be available for NB data transmission). In some embodiments, the NB device can, by the computing device, store the information gathered by performing the scan of method 600. In other embodiments, the NB device can use the reported and/or stored information to modify operations as described above.

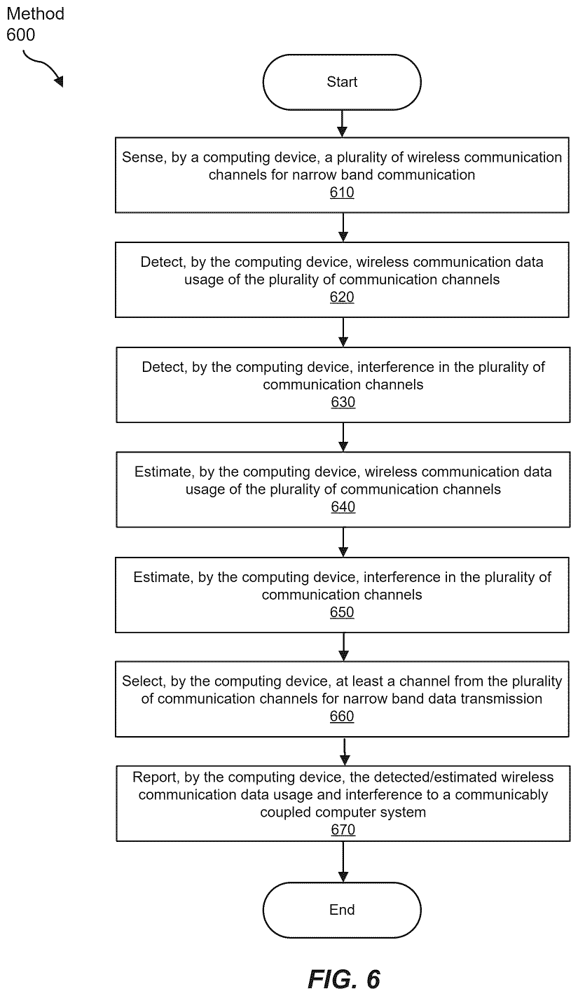

FIG. 6 is a flow diagram of an exemplary computer-implemented method 600 for providing a coexistence of wireless technologies. The operations shown in FIG. 6 may be performed by any suitable computer-executable code and/or computing system, including the system illustrated in FIG. 7. In one example, each of the operations shown in FIG. 6 may represent an algorithm whose structure includes and/or is represented by multiple sub-operations, examples of which will be provided in greater detail below.

The systems described herein may perform operation 610 in a variety of ways. In one example, as illustrated in FIG. 6, at operation 610 one or more of the systems described herein can sense, by a computing device, a plurality of wireless communication channels for NB communication (e.g., NB data transmission and/or NB data receiving). For example, a NB device can sense a range of wireless communication channels that the NB device intends to operate on to detect utilization of these channels by Wi-Fi and/or other wireless technologies (including Bluetooth®).

The systems described herein may perform operation 620 in a variety of ways. In one example, at operation 620 the NB device can detect, by the computing device, any wireless communication data usage of the plurality of sensed wireless communication channels. For example, at operation 620 the system can detect the presence of another technology, or the system can detect the bandwidth consumed by the other technology. In some embodiments, the detecting operation 620 can occur in a single predetermined time period such that the detecting operation 620 need not pause for data transmission. In a preferred embodiment, performing the detecting operation 620 in a single time period can be performed prior to the flow of communications traffic (e.g., prior to a data transmission). In some embodiments, the single time period can include a predetermined stopping point.

The systems described herein may perform operation 630 in a variety of ways. In one example, at operation 630 the NB device can detect, by the computing device, any interference in the sensed wireless communication channels. For example, at operation 630 the system can detect the presence of interference from another technology and/or a co-located technology. In some embodiments, the detecting operation 630 can occur in a single predetermined time period such that the detecting operation 630 need not pause for data transmission. In a preferred embodiment, performing the detecting operation 630 in a single time period can be performed prior to the flow of communications traffic (e.g., prior to a data transmission). In some embodiments, the single time period can include a predetermined stopping point.

In other embodiments, the NB device can repeatedly sense the wireless communication channel (or a group of channels occupied by a wider-band technology) to estimate the percentage (or relative) utilization of the sensed wireless communication channels. The systems described herein may perform operation 640 in a variety of ways. In one example, at operation 640 the NB device can estimate, by the computing device, the wireless communication data usage of the plurality of communication channels by performing the detecting operation 620 over a plurality of time periods. In other words, the NB device can perform the sensing and detecting operations 610, 620 repeatedly to build an estimated channel usage based on preceding sensing and detecting operations 610, 620. Likewise, the estimating operation 630 can be performed over a plurality of time periods to continually optimize channel selection and the coexistence of the NB and other wireless data transmissions.

In other embodiments, the NB device can repeatedly sense the wireless communication channel (or a group of channels occupied by a wider-band technology) to estimate the interference within the sensed wireless communication channels. The systems described herein may perform operation 650 in a variety of ways. In one example, at operation 650, the NB device can estimate, by the computing device, the interference in the plurality of communication channels by performing the detecting operation 630 over a plurality of time periods. In other words, the NB device can perform the sensing and detecting operations 610, 630 repeatedly to build an estimated interference quantity based on preceding sensing and detecting operations 610, 630. Likewise, the estimating operation 650 can be performed over a plurality of time periods to continually optimize channel selection and the coexistence of the NB and other wireless data transmissions.

The systems described herein may perform operation 660 in a variety of ways. In one example, as shown in FIG. 6, at operation 660, the NB device can select, by the computing device, at least one channel from the plurality of communication channels to use for NB data transmission. In some embodiments, the NB device may hop between multiple channels while in other embodiments, the NB device can operate on one channel. In some embodiments, wireless communication channels determined as busy (e.g., consumed by a high percentage of Wi-Fi transmission, having too much interference, or the like) may be deemed unacceptable for the NB data transmission, while in others the NB device may operate on these channels with additional rules and restrictions (e.g., performing the sensing operation 310 before NB data transmission or operating for a lesser duration compared to channels which are determined to be available for NB data transmission).

The systems described herein may perform operation 670 in a variety of ways. In one example, as shown in FIG. 6, at operation 670, the NB device can, by the computing device, report the detected wireless communication data usage, the detected interference, the estimated wireless communication data usage, and the estimated interference to a communicably coupled computer system. In some embodiments, the NB device can, by the computing device, store, in a memory, the information gathered by performing the scan of method 600. In other embodiments, the NB device can use the reported and/or stored information to modify operations as described above.

In some embodiments, a system 700 can be used to perform the methods described above. For example, system 700 can include a sensing module 710, a detecting module 720, an interference detecting module 730, an estimating module 740, an interference estimating module 750, a selecting module 760, and/or a reporting module 770. In some embodiments, the sensing module 710, stored in memory 780, can sense a plurality of communication channels for NB communication before NB data transmission. In further embodiments, system 700 can include the detecting module 720, stored in memory 780, that detects wireless communication data usage of the plurality of communication channels. Optionally, the system 700 can include the interference detecting module 730, stored in memory 780, that detects interference in the plurality of communication channels. In other embodiments, system 700 can include the estimating module 740, stored in memory 780, that detects wireless communication data usage of the plurality of communication channels. Optionally, the system 700 can include the interference estimating module 750, stored in memory 780, that detects interference in the plurality of communication channels. In some embodiments, the system 700 can include the selecting module 760, stored in memory 780, that selects at least a channel from the plurality of communication channels for data transmission such that the wireless communication data and the NB data transmission coexist non-interferingly. Optionally, system 700 can include the reporting module 760, stored in memory 780, that reports the detected wireless communication data usage, the detected interference, the estimated wireless communication data usage, and the estimated interference to a communicably coupled computer system.

In some embodiments, system 700 can include a machine learning model 785, stored in memory 780, configured to dynamically modify the sensing module to target operational wireless communication channels, a maximum usage threshold determining module 790, stored in memory 780, configured to determine the maximum usage threshold for the wireless communication data usage, wherein the computer device will initiate the NB data transmission when the wireless communication data usage is less than the determined usage threshold, and/or a channel map providing module 795 configured to identify wireless communication channels operable for the NB data transmission and provide the channel map.

In some embodiments, the systems described herein can include a non-transitory computer-readable medium comprising one or more computer-executable instructions that, when executed by at least one processor of a computing device, cause the computing device to sense, prior to NB data transmission, a plurality of communication channels for NB communication. In some embodiments, the one or more computer-executable instructions that, when executed by at least one processor of a computing device, cause the computing device to detect, by the computer device, wireless communication data usage and/or interference in the plurality of communication channels. In other embodiments, the one or more computer-executable instructions that, when executed by at least one processor of a computing device, cause the computing device to estimate, by the computer device, wireless communication data usage and or interference of the plurality of communication channels. In some embodiments, the one or more computer-executable instructions that, when executed by at least one processor of a computing device, cause the computing device to select, by the computer device, at least a channel from the plurality of communication channels for NB data transmission.

In another embodiments, the one or more computer-executable instructions that, when executed by at least one processor of a computing device, cause the computing device to report, by the computer device, the detected wireless communication data usage, the detected interference, the estimated wireless communication data usage, and the estimated interference to a communicably coupled computer system, such that the wireless communication data and the narrow band data transmission coexist non-interferingly.

The preceding description provides systems and methods for allowing NB wireless devices to transmit (e.g., send and receive) wireless data over wireless communication channels used by wide band technologies (e.g., Wi-Fi). Wireless data coexistence, as provided herein, can streamline a user experience by providing seamless communication with both the NB devices and wide band devices. In other words, the systems and methods described herein can provide a glitch-free user experience in wireless devices.

### EXAMPLE EMBODIMENTS

Example 1: A computer-implemented method, comprising sensing, by a computer device, a plurality of wireless communication channels for narrow band communication; detecting, by the computer device, wireless communication data usage of the plurality of communication channels over a predetermined time period; estimating, by the computing device, wireless communication data usage of the plurality of communication channels over a predetermined time period; and selecting, by the computing device, at least a channel from the plurality of communication channels for narrow band data transmission, wherein the wireless communication data and the narrow band data transmission coexist non-interferingly.

Example 2: The method according to any preceding or subsequent example, wherein the sensing, detecting, estimating, and selecting operations are performed before the narrow band data transmission.

Example 3: The method according to any preceding or subsequent example, further comprising detecting, by the computer device, wireless communication data usage of the plurality of communication channels over a plurality of time periods.

Example 4: The method according to any preceding or subsequent example, further comprising estimating, by the computing device, wireless communication data usage of the plurality of communication channels over a plurality of time periods.

Example 5: The method according to any preceding or subsequent example, wherein the sensing, detecting, estimating, and selecting are performed during narrow band data transmission.

Example 6: The method according to any preceding or subsequent example, further comprising repeating the detecting operation to provide a wireless communication data usage quantity in the wireless communication channels.

Example 7: The method according to any preceding or subsequent example, further comprising selecting, by the computer device, a plurality portion of channels from the plurality of communication channels for narrow band data transmission.

Example 8: The method according to any preceding or subsequent example, wherein the plurality of wireless communication channels are segregated into sub-groups corresponding to a wireless transmission frequency.

Example 9: The method according to any preceding or subsequent example, further comprising continuous performance of the sensing, detecting, estimating, and selecting operations.

Example 10: The method according to any preceding or subsequent example, further comprising, by a machine learning model operated within the computer device, dynamically modifying the sensing operation to target operational wireless communication channels.

Example 11: The method according to any preceding or subsequent example, further comprising determining a maximum threshold for the wireless communication data usage, wherein the computer device will initiate the narrow band data transmission when the wireless communication data usage is less than the determined threshold.

Example 12: The method according to any preceding or subsequent example, further comprising providing a channel map configured to identify wireless communication channels operable for the narrow band data transmission.

Example 13: A system according to any preceding or subsequent example, comprising a sensing module, stored in memory, that, prior to a data transmission, senses a plurality of communication channels for narrow band communication; a detecting module, stored in memory, that detects wireless communication data usage of the plurality of communication channels; an estimating module, stored in memory, that estimates wireless communication data usage of the plurality of communication channels; and a selecting module, stored in memory, that selects at least a channel from the plurality of communication channels for data transmission, wherein the wireless communication data and the narrow band data transmission coexist non-interferingly.

Example 14: The system according to any preceding or subsequent example, further comprising a second detecting module, stored in memory, that detects interference in the plurality of communication channels.

Example 15: The system according to any preceding or subsequent example, further comprising a second estimating module, stored in memory, that estimates interference in the plurality of communication channels.

Example 16: The system according to any preceding or subsequent example, further comprising a reporting module, stored in memory, that reports the detected wireless communication data usage, the detected interference, the estimated wireless communication data usage, and the estimated interference to a communicably coupled computer system.

Example 17: The system according to any preceding or subsequent example, further comprising, a machine learning model, stored in memory, configured to dynamically modify the sensing module to target operational wireless communication channels.

Example 18: The system according to any preceding or subsequent example, further comprising a maximum usage threshold determining module, stored in memory, configured to determine the maximum usage threshold for the wireless communication data usage, wherein the computer device will initiate the narrow band data transmission when the wireless communication data usage is less than the determined usage threshold.

Example 19: The system according to any preceding or subsequent example, further comprising a channel map providing module configured to identify wireless communication channels operable for the narrow band data transmission and provide the channel map.

Example 20: A non-transitory computer-readable medium according to any preceding example comprising one or more computer-executable instructions that, when executed by at least one processor of a computing device, cause the computing device to:
sense, by a computer device, prior to a data transmission, a plurality of communication channels for narrow band communication;
detect, by the computer device, wireless communication data usage of the plurality of communication channels;
detect, by the computer device, interference in the plurality of communication channels;
estimate, by the computer device, wireless communication data usage of the plurality of communication channels;
estimate, by the computer device, interference in the plurality of communication channels;
select, by the computer device, at least a channel from the plurality of communication channels for data transmission; and
report, by the computer device, the detected wireless communication data usage, the detected interference, the estimated wireless communication data usage, and the estimated interference to a communicably coupled computer system.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive [data] to be transformed, transform the [data], output a result of the transformation to [perform a function], use the result of the transformation to [perform a function], and store the result of the transformation to [perform a function]. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A computer-implemented method, comprising:
sensing, by a computer device, a plurality of wireless communication channels for narrow band communication;
detecting, by the computer device, wireless communication data usage of the plurality of communication channels over a predetermined time period;
estimating, by the computing device, wireless communication data usage of the plurality of communication channels over a predetermined time period; and
selecting, by the computing device, at least a channel from the plurality of communication channels for narrow band data transmission,
wherein the wireless communication data and the narrow band data transmission coexist non-interferingly.

2. The method of claim 1, wherein the sensing, detecting, estimating, and selecting operations are performed before the narrow band data transmission.

3. The method of claim 1, further comprising detecting, by the computer device, wireless communication data usage of the plurality of communication channels over a plurality of time periods.

4. The method of claim 3, further comprising estimating, by the computing device, wireless communication data usage of the plurality of communication channels over a plurality of time periods.

5. The method of claim 4, wherein the sensing, detecting, estimating, and selecting are performed during narrow band data transmission.

6. The method of claim 1, further comprising repeating the detecting operation to provide a wireless communication data usage quantity in the wireless communication channels.

7. The method of claim 1, further comprising selecting, by the computer device, a plurality portion of channels from the plurality of communication channels for narrow band data transmission.

8. The method of claim 1, wherein the plurality of wireless communication channels are segregated into sub-groups corresponding to a wireless transmission frequency.

9. The method of claim 1, further comprising continuous performance of the sensing, detecting, estimating, and selecting operations.

10. The method of claim 1, further comprising, by a machine learning model operated within the computer device, dynamically modifying the sensing operation to target operational wireless communication channels.

11. The method of claim 1, further comprising determining a maximum threshold for the wireless communication data usage, wherein the computer device will initiate the narrow band data transmission when the wireless communication data usage is less than the determined threshold.

12. The method of claim 1, further comprising providing a channel map configured to identify wireless communication channels operable for the narrow band data transmission.

13. A system, comprising:
a sensing module, stored in memory, that, prior to a data transmission, senses a plurality of communication channels for narrow band communication;
a detecting module, stored in memory, that detects wireless communication data usage of the plurality of communication channels;
an estimating module, stored in memory, that estimates wireless communication data usage of the plurality of communication channels; and
a selecting module, stored in memory, that selects at least a channel from the plurality of communication channels for data transmission,
wherein the wireless communication data and the narrow band data transmission coexist non-interferingly.

14. The system of claim 13, further comprising a second detecting module, stored in memory, that detects interference in the plurality of communication channels.

15. The system of claim 14, further comprising a second estimating module, stored in memory, that estimates interference in the plurality of communication channels.

16. The system of claim 15, further comprising a reporting module, stored in memory, that reports the detected wireless communication data usage, the detected interference, the estimated wireless communication data usage, and the estimated interference to a communicably coupled computer system.

17. The system of claim 13, further comprising, a machine learning model, stored in memory, configured to dynamically modify the sensing module to target operational wireless communication channels.

18. The system of claim 17, further comprising a maximum usage threshold determining module, stored in memory, configured to determine the maximum usage threshold for the wireless communication data usage, wherein the computer device will initiate the narrow band data transmission when the wireless communication data usage is less than the determined usage threshold.

19. The system of claim 13, further comprising a channel map providing module configured to identify wireless communication channels operable for the narrow band data transmission and provide the channel map.

20. A non-transitory computer-readable medium comprising one or more computer-executable instructions that, when executed by at least one processor of a computing device, cause the computing device to:
sense, by a computer device, prior to a data transmission, a plurality of communication channels for narrow band communication;
detect, by the computer device, wireless communication data usage of the plurality of communication channels;
detect, by the computer device, interference in the plurality of communication channels;
estimate, by the computer device, wireless communication data usage of the plurality of communication channels;
estimate, by the computer device, interference in the plurality of communication channels;
select, by the computer device, at least a channel from the plurality of communication channels for data transmission; and
report, by the computer device, the detected wireless communication data usage, the detected interference, the estimated wireless communication data usage, and the estimated interference to a communicably coupled computer system.
